(19) United States
(12) Patent Application Publication
(10) Pub. No.: US 2010/0143584 A1
(43) Pub. Date: Jun. 10, 2010

(54) Method of Making Soft and Absorbent Tissue Products

(76) Inventor: Kou-Chang Liu, Appleton, WI (US)

Correspondence Address: KIMBERLY-CLARK WORLDWIDE, INC.;Tara Pohlkotte, 2300 Winchester Rd., NEENAH, WI, 54956, US

(21) Appl. No.: 12/630,162

(22) Filed: Dec. 3, 2009

Related U.S. Application Data
(63) Continuation of application No. 11/588,076, filed on Oct. 26, 2006.

(51) Int. Cl. B05D 7/00; B05D 1/02

(52) U.S. Cl. 427/210; 427/209

(57) ABSTRACT

Softening compositions for tissues, particularly facial tissues, include a combination of polysiloxanes and one or both of a polyalkylene oxide and a fatty alkyl derivative. The softening compositions can contain from about 30 to about 75 weight percent polysiloxane, from about 0 to about 60 weight percent polyalkylene oxide and from about 0 to about 60 weight percent fatty alkyl derivative, wherein the combined amount of the polyalkylene oxide and the fatty alkyl derivative is about 25 weight percent or greater. The resulting tissues have good softness and wettability.

This application is a continuation of U.S. Ser. No. 11/588,076 filed on Oct. 26, 2006. The entirety of U.S. Ser. No. 11/588,076 is hereby incorporated by reference.

### BACKGROUND OF THE INVENTION

The use of various polysiloxanes to soften tissue products, such as facial and bath tissue, is well known in the tissue industry. However, while polysiloxanes are effective in providing a smooth surface feel, they are generally hydrophobic and retard wettability. In addition, polysiloxanes can be expensive. Therefore there is a need for lower cost polysiloxane compositions which provide the desired level of softness without reducing the wettability of the tissue to unacceptable levels.

### SUMMARY OF THE INVENTION

It has now been discovered that certain blends of components can provide tissues with the desired balance of softness and wettability at a reduced cost compared to current polysiloxane softness compositions. More specifically, it has been found that polysiloxanes can be combined with one or more polyalkylene oxides and/or one or more fatty alkyl derivatives in the proper ratios, particularly when the polyalkylene oxide(s) and/or the fatty alkyl derivative(s) is(are) solid at room temperature, to provide improved softness compared to the polysiloxane alone, as well as good wettability for tissue products, particularly facial tissues.

Hence, in one aspect, the invention resides in a softening composition which comprises, on a solids basis, from about 30 to about 75 weight percent of one or more polysiloxanes, from about 0 to about 60 weight percent of one or more polyalkylene oxides and from about 0 to about 60 weight percent of one or more fatty alkyl derivatives, wherein the combined amount of the polyalkylene oxide(s) and the fatty alkyl derivative(s) is about 25 weight percent or greater.

In another aspect the invention resides in a tissue sheet having a topically-applied softening composition which comprises, on a solids basis, from about 30 to about 75 weight percent of one or more polysiloxanes, from about 0 to about 60 weight percent of one or more polyalkylene oxides and from about 0 to about 60 weight percent of one or more fatty alkyl derivatives, wherein the combined amount of the polyalkylene oxide(s) and the fatty alkyl derivative(s) is about 25 weight percent or greater.

The softening composition can topically applied onto one or both of the outer tissue product surfaces, such as by printing or spraying, or by any other manner known in the tissue making art. Topical addition tends to concentrate the softening composition on the surface(s) of the tissue product where its softening characteristics are most readily apparent to the consumer. The add-on amount can be from about 0.5 to about 10 weight percent, more specifically from about 0.5 to about 5 weight percent, and still more specifically from about 1 to about 3 weight percent.

Polysiloxanes useful for purposes of this invention can have one or more pendant functional groups such as amine, quaternium, aldehyde, epoxy, hydroxy, alkoxyl, polyether and carboxylic acid and its derivatives, such as amides and esters. Suitable polysiloxanes can have the following general structure:

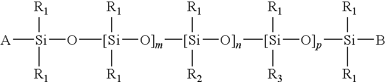

wherein:
“m” is from 10 to 100,000;
“n” is from 1 to 10,000;
“p” is from 0 to 1,000;
“A” and “B” are independently a hydroxyl, C₁ to C₂₀ or R₂,
R₁, R₂ and R₃ are distributed in random or block fashion;
R₁ is a C₁ to C₈ radical, which can be straight chain, branched or cyclic;
R₂ is a C₁ to C₈ radical, which can be straight chain, branched or cyclic, or of the structure:

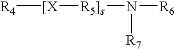

wherein

R₄ and R₅ are independently a C₂ to C₈ alkylene diradical, which can be straight chain or branched, substituted, or unsubstituted;

X is an oxygen or N—R₈;

R₆, R₇ and R₈ are independently hydrogen, a substituted or unsubstituted

C₁ or C₂, a substituted or unsubstituted straight chain or branched or cyclic

C₃ to C₂₀ alkyl radical, or an acyl radical, such as an acetyl radical; and

“s” is 0 or 1;

R₃ is of the structure: R₉—Y—[C₂H₄O]ᵣ—[C₃H₆O]_{q}—R₁₀

wherein

Y is an oxygen or N—R₁₁;

R₉ is a C₂ to C₈ alkylene diradical, which can be straight chain or branched, substituted or unsubstituted;

R₁₀ and R₁₁ are independently hydrogen, a substituted or unsubstituted C₁ or C₂, a substituted or unsubstituted, straight chain or branched or cyclic C₃ to C₂₀ alkyl radical;

“r” is from 1 to 100,000; and

“q” is from 0 to 100,000.

When R₂=R₁, “A” and “B” can also be a nitrogen quaternium.

Examples of suitable commercially available polysiloxanes include AF-2340, AF-2130, HAF-1130, EAF-3000, EAF-340, EAF-15, AF-2740, WR-1100, WR-1300 and Wetsoft CTW from Kelmar/Wacker; DC-8822, DC-8566, DC-8211, DC-SF8417, DC-2-8630, DC-NSF, DC-8413, DC-SSF, DC-8166 from Dow Corning; SF-69, SF-99, SF-1023 from GE Silicones and Tegopren 6924, Tegopren 7990, Tego IS4111 from Goldschmidt/Degussa.

The amount of the polysiloxane in the softening composition, on a solids basis, can be from about 30 to about 75 weight percent, more specifically from 30 to about 70 weight percent, more specifically from about 40 to about 70 weight percent, and still more specifically from about 50 to about 70 weight percent.

Polyalkylene oxides suitable for purposes of this invention can have the following general structure:

R₁₂—[C₂H₄O]ᵢ—[C₃H₆O]ⱼ—[CₜH₂ₜO]ᵥ—R₁₃

wherein:
R₁₂ and R₁₃ are independently a hydrogen, a substituted or unsubstituted C₁ to C₆ alkyl radical, a straight chain or branched C₁ to C₆ alkyl radical, or a cyclic C₁ to C₆ alkyl radical;
“i”, “j” and “v” are independently from 0 to 100,000, with the oxide moieties are distributed along the polymer backbone randomly or as blocks;
“i+j+v” is equal to or greater than 10; and
“t” is from 4 to 10.

The polyalkylene oxide can be in a liquid or solid state at room temperature. However, a polyalkylene oxide which is solid at room temperature is preferred. Examples of suitable commercially available polyalkylene oxides are Carbowax PEG 600, Carbowax PEG 1450 and Carbowax PEG 8000 from Dow Chemical.

The amount of the polyalkylene oxide in the softening composition, on a solids basis, can be from 0 to about 60 weight percent, more specifically from about 1 to about 60 weight percent, more specifically from about 10 to about 60 weight percent, more specifically from about 20 to about 60 weight percent, more specifically from about 30 to about 60 weight percent, and still more specifically from about 30 to about 50 weight percent.

Fatty alkyl derivatives suitable for purposes of this invention can have the following general structure:

R₁₄-G

wherein:
R₁₄ is a C₈ to C₄₀ alkyl radical, which can be substituted or unsubstituted, primary, secondary or tertiary; straight chain, branched or cyclic; and
“G” is hydroxy, amine, sulfonate, sulfate, phosphate, acid or acid derivative, or -Q-[C₂H₄O]ᵢ—[C₃H₆O]ⱼ—[CₜH₂ₜO]ᵥ—R₁₃ radical;
wherein
“Q” is an oxygen radical, an NH radical or N—[C₂H₄O]ᵢ—[C₃H₆O]ⱼ—[CₜH₂ₜO]ᵥ—R₁₃ radical;
R₁₃ is a hydrogen, a substituted or unsubstituted C₁ to C₆ alkyl radical, a straight chain or branched C₁ to C₆ alkyl radical, or a cyclic C₁ to C₆ alkyl radical;
“i”, “j” and “v” are independently from 0 to 100,000, where the oxide moieties are distributed along the polymer backbone randomly or as blocks;
“i+j+v” is equal to or greater than 10; and
“t” is from 4 to 10.

The fatty alkyl derivatives can be in liquid or solid state at room temperature. However, a fatty alkyl derivative which is a solid at room temperature is preferred. Examples of commercially available suitable fatty alkyl derivatives are glycerol stearate, glycerol dilaurate, sorbitan monopalmitate, sorbitan tristearate, sorbitan sesquioleate polyoxyethylene sorbitan palmitate, 9-EO ethoxylated tridecylalcohol, Ceteth-10, Ceteth-12 (12-EO ethoxylated cetyl alcohol) and Ceteth-20. More particularly, suitable commercially available fatty alkyl derivatives include Pluraface A-38, Macol CSA 20 and Macol LA 12 from BASF; Armeen 16D, Armeen 18D, Armeen HTD, Armeen 2C, Armeen M2HT, Armeen 380, Ethomeen 18/15 Amid O, Witconate 90, Witconate AOK, and Witcolate C from Akzo Nobel.

The amount of the fatty alkyl derivative in the softening composition, on a solids basis, can be from 0 to 60 weight percent, more specifically from about 1 to about 60 weight percent, more specifically from about 1 to about 50 weight percent, more specifically from about 10 to about 50 weight percent, more specifically from about 20 to about 50 weight percent, and still more specifically from about 20 to about 40 weight percent.

In the interests of brevity and conciseness, any ranges of values set forth in this specification are to be construed as written description support for claims reciting any sub-ranges having endpoints which are whole number values within the specified range in question. By way of a hypothetical illustrative example, a disclosure in this specification of a range of from 1 to 5 shall be considered to support claims to any of the following sub-ranges: 1-4; 1-3; 1-2; 2-5; 2-4; 2-3; 3-5; 3-4; and 4-5.

### EXAMPLES

Three-ply, wet-pressed, creped facial tissue products were made with different softening compositions of this invention as described below and tested for softness and wettability. In general, the tissue base sheets were produced using a conventional wet-pressed tissue making process well known in the art. More particularly, an aqueous suspension of papermaking fibers was issued from a layered headbox onto a forming fabric. The furnish consisted of 70 weight percent hardwood (eucalyptus) fibers and 30 weight percent softwood fibers. A vacuum box beneath forming fabric was adapted to remove water from the fiber furnish to assist in forming a web. The newly formed web was transferred to a felt with aid of a pick up roll. While supported by the felt, the tissue web was lightly pressed onto the surface of a Yankee dryer using a press roll. The dried web was creped from the surface of the Yankee dryer and the resulting single-ply tissue base sheet was wound onto a parent roll. Thereafter, the base sheets from three like parent rolls were unwound and converted into a three-ply basesheet for subsequent application of the various softening compositions. The finished basis weight of the three-ply base sheet was about 22.7 pounds per 2880 square feet.

The softening composition was simultaneously applied to both surfaces of the three-ply basesheet by rotogravure printing. The gravure rolls were electronically engraved, chrome over copper rolls supplied by Southern Graphics Systems, located at Louisville, Ky. The rolls had a line screen of 360 cells per lineal inch and a volume of 1.5 Billion Cubic Microns (BCM) per square inch of roll surface. Typical cell dimensions for this roll were 65 microns in length, 110 microns in width, and 13 microns in depth. The rubber backing offset applicator rolls were a 75 Shore A durometer cast polyurethane supplied by American Roller Company, located at Union Grove, Wis. The process was set up to a condition having 0.375 inch interference between the gravure rolls and the rubber backing rolls and 0.003 inch clearance between the facing rubber backing rolls. The simultaneous offset/offset gravure printer was run at a speed of 2000 feet per minute. This process yielded a solids add-on level of about 1.0 weight percent based on the dry weight of the finished tissue product. (0.5 dry weight percent on each side of the product.

After the tissue products were made, they were tested for geometric mean tensile strength, wettability and softness.

As used herein, the “geometric mean tensile strength” (GMT) is the square root of the product of the dry machine direction tensile strength multiplied by the dry cross-machine direction tensile strength and is expressed as grams per 3 inches of sample width. The machine direction tensile strength is the peak load per 3 inches of sample width when a sample is pulled to rupture in the machine direction. Similarly, the cross-machine direction (CD) tensile strength is the peak load per 3 inches of sample width when a sample is pulled to rupture in the cross-machine direction. More specifically, samples for tensile strength testing are prepared by cutting a 3 inches (76.2 mm) wide by 5 inches (127 mm) long strip in either the machine direction (MD) or cross-machine direction (CD) orientation using a JDC Precision Sample Cutter (Thwing-Albert Instrument Company, Philadelphia, Pa., Model No. JDC 3-10, Serial No. 37333). The instrument used for measuring tensile strengths is an MTS Systems Sintech 11S, Serial No. 6233. The data acquisition software is MTS TestWorks® for Windows Ver. 3.10 (MTS Systems Corp., Research Triangle Park, N.C.). The load cell is selected from either a 50 Newton or 100 Newton maximum, depending on the strength of the sample being tested, such that the majority of peak load values fall between 10-90% of the load cell's full scale value. The gauge length between jaws is 4+/−0.04 inches (101.6+/−1 mm). The jaws are operated using pneumatic-action and are rubber coated. The minimum grip face width is 3 inches (76.2 mm), and the approximate height of a jaw is 0.5 inches (12.7 mm). The crosshead speed is 10+/−0.4 inches/min (254+/−1 mm/min), and the break sensitivity is set at 65%. The sample is placed in the jaws of the instrument, centered both vertically and horizontally. The test is then started and ends when the specimen breaks. The peak load is recorded as either the “MD tensile strength” or the “CD tensile strength” of the specimen depending on direction of the sample being tested. At least six (6) representative specimens are tested for each product or sheet, taken “as is”, and the arithmetic average of all individual specimen tests is either the MD or CD tensile strength for the product or sheet.

Wettability of the tissue products is determined by the “Wet Out Time”, which is related to absorbency, and is the time it takes for a prepared sample to completely wet out when placed in water. More specifically, the Wet Out Time is determined by cutting 20 product sheets of the tissue sample into 2.5 inch squares. The number of product sheets used in the test is independent of the number of plies per sheet of product. (For a 3-ply product were are 60 plies in each pad.) The 20 square sheets are stacked together and stapled at each corner to form a pad. The pad is held close to the surface of a constant temperature distilled water bath (23±2° C.), which is the appropriate size and depth to ensure the saturated specimen dose not contact the bottom of the container and the top surface of the water at the same time, and dropped flat onto the water surface, staple points down. The time taken for the pad to become completely saturated, measured in seconds, is the Wet out Time for the sample and represents the absorbent rate of the tissue. Increases in the Wet Out Time represent a decrease in the absorbent rate.

Softness of the tissue products was determined by a trained in-hand ranking panel, which provides a basic assessment of the softness and stiffness characteristics of a tissue product. The ranking panel is trained to provide holistic assessments as close as possible to those that a typical consumer might provide. In carrying out the test, two different assessments are made: Softness and Softness-on-Face. The Softness test involves evaluating the velvety, silky or fuzzy feel of the tissue sample when rubbed between the thumb and fingers. The Softness-on-Face test involves rubbing the tissue sample against the face, including the area between the nose and lips. Rank data generated for each sample code by the panel are analyzed using a proportional hazards regression model. This model assumes computationally that the panelist proceeds through the ranking procedure from most of the attribute being assessed to least of the attribute. The softness test results are presented in the tables below as log odds values. The log odds are the natural logarithm of the risk ratios that are estimated for each code from the proportional hazards regression model. Larger log odds indicate the attribute of interest is perceived with greater intensity.

### Example 1

Two tissue softening compositions were prepared and supplied by the Kelmar Division of Wacker Chemical Corporation, Duncan, S.C. The relevant chemical components of the formulations are set forth in Table 1. Tissue samples were prepared as described above by gravure coating the two formulations on a three-ply, wet-pressed, creped facial tissue basesheet. A total add-on of 1 weight percent (0.5 weight percent on each side) was evenly coated on both sides of the basesheet. The treated basesheets were then converted into folded facial tissue products. (The percentage of each component, on a solids basis, is in parentheses).

TABLE 1

| | | 12-EO | 9-EO | Water and other |
|---|---|---|---|---|
| | Polysiloxane | Ethoxylated | Ethoxylated | formulation aids |
| Formulation | AF-23 | Cetyl Alcohol | Tridecylalcohol | balance to 100% |
| 1 (Control) | 30% (83%) | 0% (0%) | 6% (17%) | Water and other |
| | | | | formulation aids |
| | | | | balance to 100% |
| 2 (Invention) | 22.5% (67%) | 5% (15%) | 6% (18%) | Water and other |
| | | | | formulation aids |
| | | | | balance to 100% |

The GMT and Wet Out Time of the facial tissue products were measured and the Softness and Softness-on-Face of the tissue products were evaluated. The results are set forth in Table 2 below.

TABLE 2

| Formulation | GMT | WOT | Soft-on-Face | Softness |
|---|---|---|---|---|
| 1 (Control) | 933 | 34.5 | 0.2308 | −0.0646 |
| 2 (Invention) | 929 | 25.6 | 0.9738 | 0.3842 |

The results illustrate that at similar physical strength (GMT), the tissue product treated with the softening chemical composition of this invention (Formulation 2) has a shorter Wet Out Time (or better wettability) and was softer in general and softer on the face when compared with the tissue product treated with the control (Formulation 1) (In Formulation 1, the combined amount of the polyalkylene oxide(s) and the fatty alkyl derivative(s) is less than 25 weight percent.)

### Example 2

Softening compositions designated as Formulations 3-8 in Table 3 were prepared, applied to tissue samples and tested as described in Example 1. (The percentage of each component, on a solids basis, is in parentheses). The test results are set forth in Table 4.

TABLE 3

| | | Polyethylene | 9-EO | Water and other |
|---|---|---|---|---|
| | Polysiloxane | Oxide | Ethoxylated | formulation aids |
| Formulation | (AF-23) | (PEG 1450) | Tridecylalcohol | balance to 100% |
| 3 (Control) | 30% (83%) | 0% (0%) | 6% (17%) | Water and other |
| | | | | formulation aids |
| | | | | balance to 100% |
| 4 (Invention) | 21% (58%) | 9% (25%) | 6% (17%) | Water and other |
| | | | | formulation aids |
| | | | | balance to 100% |
| 5 (Invention) | 18% (50) | 12% (33%) | 6% (17%) | Water and other |
| | | | | formulation aids |
| | | | | balance to 100% |
| 6 (Invention) | 15% (42%) | 15% (42%) | 6% (17%) | Water and other |
| | | | | formulation aids |
| | | | | balance to 100% |
| 7 (Invention) | 12% (33%) | 18% (50%) | 6% (17%) | Water and other |
| | | | | formulation aids |
| | | | | balance to 100% |
| 8 (Invention) | 9% (25%) | 21% (58%) | 6% (17%) | Water and other |
| | | | | formulation aids |
| | | | | balance to 100% |

TABLE 4

| Formulation | GMT | WOT | Soft-on-Face | Softness |
|---|---|---|---|---|
| 3 (Control) | 964 | 32.2 | 0.5053 | −0.0344 |
| 4 (Invention) | 975 | 25.6 | 0.7572 | 0.1405 |
| 5 (Invention) | 980 | 30.3 | 0.9222 | −0.1781 |
| 6 (Invention) | 979 | 30.9 | 0.8172 | 0.1056 |
| 7 (Invention) | 971 | 22.9 | 0 | 0 |
| 8 (Invention) | 1043 | 16.7 | 0.3191 | −1.0158 |

The results shown in Table 4 illustrate that at similar physical strength (GMT), tissue products treated with the softening compositions of this invention, such as the tissue product treated with Formulation 4, has a shorter Wet Out Time (better wettability) and was softer in general and softer on the face when compared with the tissue product treated with the control (Formulation 3).

It will be appreciated that the foregoing description and examples, given for purposes of illustration, are not to be construed as limiting the scope of this invention, which is defined by the following claims and all equivalents thereto.

We claim:

1. A method of making a soft tissue comprising topically applying from about 0.5 to about 10 dry weight percent of a softening composition to one or both outer surfaces of a tissue sheet, wherein said softening composition comprises, on a solids basis, from about 30 to about 75 weight percent of one or more polysiloxanes, from about 1 to about 60 weight percent of one or more polyalkylene oxides and from about 1 to about 60 weight percent of one or more fatty alkyl derivatives, wherein the combined amount of the polyalkylene oxide(s) and the fatty alkyl derivative(s) is about 25 weight percent or greater.

2. The method of claim 1 wherein one or more of the polysiloxanes has the following general structure: 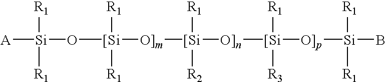
wherein:
“m” is from 10 to 100,000;
“n” is from 1 to 10,000;
“p” is from 0 to 1,000;
“A” and “B” are independently a hydroxyl, C₁ to C₂₀ or R₂;
R₁, R₂ and R₃ are distributed in random or block fashion;
R₁ is a C₁ to C₈ radical, which can be straight chain, branched or cyclic;
R₂ is a C₁ to C₈ radical, which can be straight chain, branched or cyclic, or of the structure: 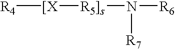
wherein
R₄ and R₅ are independently a C₂ to C₈ alkylene diradical, which can be straight chain or branched, substituted, or unsubstituted;
X is an oxygen or N—R₈;
R₆, R₇ and R₈ are independently hydrogen, a substituted or unsubstituted
C₁ or C₂, a substituted or unsubstituted straight chain or branched or cyclic
C₃ to C₂₀ alkyl radical, or an acyl radical, such as an acetyl radical; and
“s” is 0 or 1;
R₃ is of the structure: R₉—Y—[C₂H₄O]ᵣ—[C₃H₆O]_{q}—R₁₀
wherein
Y is an oxygen or N—R₁₁;
R₉ is a C₂ to C₈ alkylene diradical, which can be straight chain or branched, substituted or unsubstituted;
R₁₀ and R₁₁ are independently hydrogen, a substituted or unsubstituted C₁ or C₂, a substituted or unsubstituted, straight chain or branched or cyclic C₃ to C₂₀ alkyl radical;
“r” is from 1 to 100,000; and
“q” is from 0 to 100,000.

3. The method of claim 2 wherein R₂ is an alkylene substituted with a di-amine or a mono-amine.

4. The method of claim 2 wherein R₂=R₁ and “A” and “B” are a quaternary nitrogen group.

5. The method of claim 1 wherein the polyalkylene oxide has the following general structure:
R₁₂—[C₂H₄O]ᵢ—[C₃H₆O]ⱼ—[C₃H₆O]ⱼ—[CₜH₂ₜO]ᵥ—R₁₃
wherein:
R₁₂ and R₁₃ are independently a hydrogen, a substituted or unsubstituted C₁ to C₆ alkyl radical, a straight chain or branched C₁ to C₆ alkyl radical, or a cyclic C₁ to C₆ alkyl radical;
“i”, “j” and “v” are independently from 0 to 100,000, with the oxide moieties are distributed along the polymer backbone randomly or as blocks;
“i+j+v” is equal to or greater than 10; and
“t” is from 4 to 10.

6. The method of claim 1 wherein the polyakylene oxide is a polyethylene oxide.

7. The method of claim 1 wherein the polyakylene oxide is polyethylene glycol.

8. The method of claim 1 wherein the fatty alkyl derivative has the following general structure:
R₁₄-G
wherein:
R₁₄ is a C₈ to C₄₀ alkyl radical, which can be substituted or unsubstituted, primary, secondary or tertiary; straight chain, branched or cyclic; and
“G” is hydroxy, amine, sulfonate, sulfate, phosphate, acid or acid derivative, or -Q-[C₂H₄O]ᵢ—[C₃H₆O]ⱼ—[CₜH₂ₜO]ᵥ—R₁₃ radical;
wherein
“Q” is an oxygen radical, an NH radical or N—[C₂H₄O]ᵢ—[C₃H₆O]ⱼ—[CₜH₂ₜO]ᵥ—R₁₃ radical;
R₁₃ is a hydrogen, a substituted or unsubstituted C₁ to C₆ alkyl radical, a straight chain or branched C₁ to C₆ alkyl radical, or a cyclic C₁ to C₆ alkyl radical;
“i”, “j” and “v” are independently from 0 to 100,000, where the oxide moieties are distributed along the polymer backbone randomly or as blocks;
“i+j+v” is equal to or greater than 10; and
“t” is from 4 to 10.

9. The method of claim 1 wherein the fatty alkyl derivative is an ethoxylated alcohol or a mixture of ethoxylated alcohols.

10. The method of claim 1 wherein the fatty alkyl derivative is an ethoxylated tridecyl alcohol.

11. The method of claim 1 wherein the fatty alkyl derivative is an ethoxylated cetyl alcohol.

12. The method of claim 1 wherein the polysiloxane is an amino-derivatized polysiloxane and the fatty alkyl derivative is an alkylenoxylated alcohol.

13. The method of claim 1 wherein the polysiloxane is an amino-derivatized polysiloxane and the fatty alkyl derivative is an alkylenoxylated amine.

14. The method of claim 1 wherein the tissue softening composition comprises, on a solids basis, about 70 weight percent of an amino-polysiloxane and about 30 weight percent of an ethoxylated alcohol or a mixture of ethoxylated alcohols.

15. The method of claim 1 wherein the tissue softening composition comprises, on a solids basis, from about 50 to about 70 weight percent of an amino-polysiloxane and from about 30 to about 50 weight percent polyethylene glycol.

16. The method of claim 1 wherein the tissue softening composition comprises, on a solids basis, from about 50 to about 70 weight percent of an amino-polysiloxane and from about 30 to about 50 weight percent of a mixture of at least one polyethylene glycol and at least one fatty alkyl derivative.

17. The method of claim 1 wherein the tissue softening composition is sprayed onto one or both surfaces of the tissue sheet.

18. The method of claim 1 wherein the tissue softening composition is printed onto one or both surfaces of the tissue sheet.
